(19) United States
(12) Patent Application Publication
(10) Pub. No.: US 2024/0347793 A1
(43) Pub. Date: Oct. 17, 2024

(54) LITHIUM-ION BATTERY WITH PRE-FORMED SOLID ELECTROLYTE INTERFACE LAYER AND IMPROVED SPECIFIC CAPACITY AFTER INITIAL CHARGE

(71) Applicant: Brian G. Morin, Greenville, SC (US)

(72) Inventor: Brian G. Morin, Greenville, SC (US)

(21) Appl. No.: 18/407,401

(22) Filed: Jan. 8, 2024

Related U.S. Application Data
(63) Continuation of application No. 14/992,993, filed on Jan. 11, 2016, now abandoned.

(51) Int. Cl. H01M 10/44; H01M 4/133; H01M 10/0525; H01M 50/44

(52) U.S. Cl. CPC H01M 10/446; H01M 4/133; H01M 10/0525; H01M 50/44

(57) ABSTRACT

A method for producing a lithium-ion battery is disclosed. The method comprises the steps of assembling a cell including an interior volume comprising an anode, a cathode, and a separator; filling the interior volume of the cell with an electrolyte; connecting the anode and the cathode to a charging device; charging the cell at a rate less than or equal to C/6 until the cell reaches a voltage capacity; and charging the cell at a voltage for greater than six hours. The invention further encompasses such a method wherein the voltage capacity is greater than or equal to 3.4 volts. The invention further encompasses such a method wherein the voltage is greater than 3.4 volts. The resultant batteries may comprise an efficient and properly formed solid electrolyte interface layer.

### CROSS-REFERENCE TO RELATED APPLICATION

This is a continuation of co-pending U.S. patent application Ser. No. 14/992,993, filed on Jan. 11, 2016, the entirety thereof being incorporated herein.

### FIELD OF THE INVENTION

The present invention relates to the method of producing a lithium-ion battery comprising an insulating (nonconductive) microporous polymeric battery separator comprised of a single layer of enmeshed microfibers and nanofibers. The overall production method is highly efficient and yields a proper solid electrolyte interface (SEI) layer on the anode of the battery. The method of manufacturing such a separator, the method of utilizing such a separator within a battery device, and the method of producing a solid electrolyte interface layer are all encompassed within this invention.

### BACKGROUND OF THE PRIOR ART

locations and for portable applications. Through the controlled movement of ions between electrodes (anode and cathode), a power circuit is generated, thereby providing a source of electricity that can be utilized until the excess ions in one electrode are depleted and no further electrical generation is possible. In more recent years, rechargeable batteries have been created to Batteries have been utilized for many years for electrical energy storage in remote allow for longer lifetimes for such remote power sources, albeit through the need for connecting such batteries to other electrical sources for a certain period of time. All in all, however, the capability of reusing such a battery has led to greater potentials for use, particularly through cell phone and laptop computer usage and, even more so, to the possibility of automobiles that solely require electricity to function.

Such batteries typically include at least five distinct components. A case (or container) houses everything in a secure and reliable manner to prevent leakage to the outside as well as environmental exposure inside. Within the case are an anode and a cathode, separated effectively by a separator, as well as an electrolyte solution (low viscosity liquid) that transport ions through the separator between the anode and cathode. The rechargeable batteries of today and, presumably tomorrow, will run the gamut of rather small and portable devices, but with a great deal of electrical generation potential in order to remain effective for long periods between charging episodes, to very large types present within automobiles, as an example, that include large electrodes (at least in surface area) that must not contact one another and a large number of ions that must consistently and constantly pass through a membrane to complete the necessary circuit, all at a level of power generation conducive to providing sufficient electricity to run an automobile motor. As such, the capability and versatility of battery separators in the future must meet certain requirements that have yet to be provided within the current industry.

Generally speaking, battery separators have been utilized since the advent of closed cell batteries to provide necessary protection from unwanted contact between electrodes as well as to permit effective transport of ions within power generating cells. Typically, such materials have been of film structure, sufficiently thin to reduce the weight and volume of a battery device while imparting the necessary properties noted above at the same time. Such separators must exhibit other characteristics, as well, to allow for proper battery function. These include chemical stability, suitable porosity of ionic species, effective pore size for electrolyte transfer, proper permeability, effective mechanical strength, and the capability of retaining dimensional and functional stability when exposed to high temperatures (as well as the potential for shutdown if the temperature rises to an abnormally high level).

In greater detail, then, the separator material must be of sufficient strength and constitution to withstand a number of different scenarios. Initially, the separator must not suffer tears or punctures during the stresses of battery assembly. In this manner, the overall mechanical strength of the separator is extremely important, particularly as high tensile strength material in both the machine and cross (i.e., transverse) directions allows the manufacturer to handle such a separator more easily and without stringent guidelines lest the separator suffer structural failure or loss during such a critical procedure. Additionally, from a chemical perspective, the separator must withstand the oxidative and reductive environment within the battery itself, particularly when fully charged. Any failure during use, specifically in terms of structural integrity permitting abnormally high amounts of current to pass or for the electrodes to touch, would destroy the power generation capability and render the battery totally ineffective. Thus, even above the ability to weather chemical exposure, such a separator must also not lose dimensional stability (i.e., warp or melt) or mechanical strength during storage, manufacture, and use, either, for the same reasons noted above.

Simultaneously, however, the separator must be of proper thickness to, in essence, facilitate the high energy and power densities of the battery, itself. A uniform thickness is quite important, too, in order to allow for a long-life cycle as any uneven wear on the separator will be the weak link in terms of proper electrolyte passage, as well as electrode contact prevention.

In all lithium-ion batteries, the electrolyte is unstable in the presence of the anode (carbonaceous). Because of this, the electrolyte degrades and forms a surface layer on the anode, called the solid electrolyte interface layer, which is formed of degraded and polymerized electrolyte on the surface of the anode. This layer prevents further decay of the electrolyte, and is conductive to lithium ions, so allows the functioning of the battery to charge and discharge continually.

With normal lithium-ion separators, which have a pore size of ˜0.01 microns, or 10 nm, the formation of the SEI layer proceeds slowly due to the slow movement of electrolyte to the anode surface. Thus the separator acts as a regulator for the SEI layer formation process.

In production, manufacturers will attempt to run this process as quickly as possible, using minimal current and lowest voltage to minimize the time and expense of the process and maximize the utilization of the equipment.

With nonwoven separators, which have a pore size that is larger than 10 nm, more on the order of 200-500 nm, the SEI layer formation is not governed by the pore size of the separator, and proceeds faster. This creates a layer which is irregular and more open, and does not completely protect the anode, allowing further decay. It thus takes longer to form the SEI layer for nonwoven separators and it should be governed by current flow, rather than separator pore size. In addition, some nonwoven separators are made of such material and have such porosity that the SEI layer may form on the nonwoven fibers themselves, and the formation process should allow sufficient time and current to allow this formation, which may be slower than that on the electrodes.

One issue is that if a “normal” formation process is used for lithium-ion batteries with a nonwoven separator, or any separator of high porosity and larger pore size, is that the SEI layer will not be completely formed, and areas of the anode will still be exposed to the electrolyte. If this happens, when the cell is taken off of formation (disconnected electrically), the SEI layer will continue to form, and this process will drain charge from the cell. This SEI layer formation continuation can be misinterpreted as a “soft short” within the cell, or lead to high self-discharge until the cell is properly formed.

For batteries including such a separator, a proper charging cycle must be utilized in order to create a sufficient solid electrolyte interface (SEI) layer on the anode of the battery, and also on the fibers of the separator itself. Such a cycle may include providing a first current to the battery during a first portion of the cycle in order to properly deposit electrolyte on the anode. A second current may be utilized in a second portion of the cycle. Further, a soak at high voltage may be required during the initial formation of the solid electrolyte interface layer in order to achieve low initial self-discharge.

To date, the standards in place today do not comport to such critical considerations concerning the deposition of the solid electrolyte interface layer. Thus, there still exists a need to provide parameters for deposition that allow for a sufficient solid electrolyte interface layer to deposit on the anode of a battery. Currently, such a manufacturing method to such an extent has yet to be explored throughout the battery separator industry. As such, an effective and rather simple and straightforward battery manufacturing method in terms of providing a sufficient voltage soak and current providing a sufficient electron transport and electrolyte deposition, is prized within the rechargeable battery industry; to date, such a method has not been developed.

### Advantages and Summary of the Invention

A distinct advantage of the present invention is the ease in manufacturing a lithium-ion battery with an efficient and properly formed solid electrolyte interface layer. Another distinct advantage is that current and not the pore size of the separator limit the rate of formation of a solid electrolyte interface layer. Another distinct advantage is that a slow process and high voltage produces a uniform and complete coverage of the anode of the battery.

Lithium iron phosphate (LFP) cells have high-rate capability, good cycle life and extraordinary safety compared to other lithium-ion batteries (LIB). Often, they compete with lead acid batteries in applications such as e-bikes, backup power and UPS systems, power for light electric vehicles (fork lifts, golf carts, etc) and grid storage. In these applications, they have extraordinary advantages in cycle life, energy density and charge acceptance rate. However, they suffer in both cost and safety. Converting these cells from polyolefin separators to Dreamweaver (DWI) Silver separators can increase both the safety and the cost of the cells, making them more competitive in these markets. This change can also improve the performance of LFP cells in other applications, such as power tools, electric buses and others where they compete with either nickel metal hydride (NiMH) or other LIBs.

However, some initial attempts to do a direct replacement resulted in high self-discharge after initial formation of the cells. Those cells performed equal or better on every other metric, including cycle life, high temperature cycle life, discharge capacity at various rates up to 9 C, and a complete portfolio of safety tests including hot box (150-190 C), over charge, hard short, and nail penetration. After multiple cycles, the cells also showed low self-discharge. It therefore became evident that something was different in the initial life of the cell, and it made sense to investigate the formation of the SEI layer as a likely candidate to improve the initial self-discharge of the cells.

Accordingly, this invention pertains to a method for producing a lithium-ion battery. The method comprises the steps of assembling a cell including an interior volume comprising an anode, a cathode, and a separator; filling the interior volume of the cell with an electrolyte; connecting the anode and the cathode to a charging device; charging the cell at a rate less than or equal to C/6 until the cell reaches a specified voltage; and charging the cell at a voltage for greater than six hours. The invention further encompasses such a method wherein the voltage is greater than or equal to 3.4 volts. The invention further encompasses such a method wherein the voltage is greater than 3.4 volts.

Such a method of production has yet to be investigated within the rechargeable battery art, particularly in terms of the capability of providing a sufficient solid electrolyte interface layer that may reduce self-discharge of a rechargeable battery. The use of current is particularly important, such that specific parameters provide a sufficient solid electrolyte interface layer, such that an ideal current applied is not faster than C/4, preferably not faster than C/6, and more preferably not faster than C/10 (with C being the rate required to charge the cell to full capacity in one hour). Additionally, the use of voltage is very important, such that specific parameters provide a sufficient solid electrolyte interface layer, such that an ideal voltage is achieved at greater than 3.3 volts, preferably 3.6 volts, and more preferably 3.9 volts. Furthermore, the use of current to keep the voltage above 3.6 volts, such that a sufficient amount of time to apply the current is carried out at a time greater than six hours, preferably at a time greater than 9 hours, more preferably at a time greater than 12 hours. This process allows the SEI layer to form at a rate that is limited by current (not the pore size of the separator) and also allows a slow process at high voltage which will continue to fill in any gaps and give a uniform, complete coverage of the anode.

Additionally, it should be noted that although a single-layer separator including microfibers and nanofibers together is encompassed within this invention, the utilization of multiple layers of such a fabric structure, or of a single layer of such an inventive battery separator fabric with at least one other layer of a different type of fabric, may be employed and still within the scope of the overall invention described herein.

Such battery separators as described herein are clearly useful for improving the art of primary and rechargeable batteries, but also may be used for other forms of electrolyte conducting energy storage techniques, such as capacitors, supercapacitors and ultracapacitors. Indeed, the control allowed on the pore size for such inventive separators may allow significant improvements in the energy loss, power discharge rate, and other properties of these devices.

Additionally, such battery separators which include SEI layer formation on the fibers themselves will exhibit the smaller pore size necessary for good separation. Because the SEI layer is known to be conductive to lithium ions, the conductivity of these separators with SEI layer formed thereon will also exhibit the high ionic conductivity necessary for fast and efficient charging and discharging of the device.

### BRIEF DESCRIPTION OF THE DRAWINGS

The novel features believed characteristic of the disclosed subject matter will be set forth in any claims that are filed. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 is a schematic representation of the solid electrolyte interface on the carbonaceous anode of a lithium-ion battery.

FIGS. 2 and 3 are SEM microphotographs at 1000 and 2000 magnification levels of one potentially preferred embodiment of a microfiber/nanofiber nonwoven fabric battery separator structure.

FIGS. 4 and 5 are SEM micrographs at 5000 and 10000 magnification levels of another potentially preferred embodiment of an inventive microfiber/nanofiber nonwoven fabric battery separator structure.

FIG. 6 is a graph displaying the comparison of the post self-discharge capacity and the post self-discharge open cell voltage for cells made with electrodes from a Cell Manufacturer A.

FIG. 7 is a bar graph displaying the formation variable effect on post formation cell capacity for cells from a Cell Manufacturer A.

FIG. 8 is a bar graph displaying the formation variable effect on post self-discharge residual capacity for cells made with electrodes from a Cell Manufacturer A.

FIG. 9 is a graph displaying the cross correlation between first charge time and self-discharge in lithium-ion batteries for cells made with electrodes from a Cell Manufacturer A.

FIG. 10 is a graph displaying the comparison of the post self-discharge capacity (mAh) and the post self-discharge voltage (V) for cells made with electrodes from a Cell Manufacturer B.

FIG. 11 is a bar graph displaying the formation variable effect on post formation cell capacity for cells made with electrodes from a Cell Manufacturer B.

FIG. 12 is a bar graph displaying the formation variable effect on post self-discharge residual capacity for cells made with electrodes from a Cell Manufacturer B.

FIG. 13 is a graph displaying the cross correlation between first charge time and self discharge in lithium-ion batteries for cells made with electrodes from a Cell Manufacturer B.

FIG. 14 and FIG. 15 are SEM micrographs at 15000 magnification level of a comparative prior art CELGARD® 2400 separator taken before and after teardown of a lithium iron phosphate cell, showing no appreciable formation of the SEI layer on the separator.

FIG. 16 is an SEM micrograph at 5000 magnification level of a Dreamweaver Silver 25 separator taken before inclusion in a lithium iron phosphate cell.

FIGS. 17 and 18 are SEM micrographs at 3000 and 5000 magnification level of a Dreamweaver Silver 25 separator taken after teardown of a lithium iron phosphate cell, showing significant formation of the SEI layer on the separator.

FIG. 19 is a graph showing the charge-discharge curves for the 2nd and 50th cycles of lithium iron phosphate cells cycled from 2.4 to 3.6 V comparing cells made with CELGARD® 2400 to Dreamweaver Silver 25 separators.

FIG. 20 is a graph showing the capacity for the first 50 cycles of lithium iron phosphate cells cycled at 1 C from 2.4 to 3.6 V comparing cells made with a prior art CELGARD® 2400 and inventive Dreamweaver Silver 25 separators.

FIG. 21 is a graph showing the rate capability of similar cells at 1 C, 2 C and 4 C, again comparing cells made with prior art CELGARD® 2400 and inventive Dreamweaver Silver 25 separators.

FIG. 22 shows an exploded view of an inventive rechargeable lithium-ion battery including an inventive battery separator.

### DETAILED DESCRIPTION OF ILLUSTRATIVE EMBODIMENTS

All the features of this invention and its preferred embodiments will be described in full detail in connection with the following illustrative, but not limiting drawings and examples.

### Definitions

Solid Electrolyte Interface (SEI) Layer-A layer of material formed on the carbonaceous anode through the decay of the electrolyte.

Formation-A process used to create the SEI layer, generally determined by attaching the cell to a charging device capable of controlling both current and voltage, and taking the cell through a determined voltage and current profile.

Carbonaceous Anode—An electrode capable of accepting lithium ions comprising carbonaceous materials such as graphite, hard carbon, activated carbon, and others, as generally practiced in the lithium-ion battery industry. The anode is generally a coating on a conductive material which is used to distribute and collect electronic current, called a current collector. A common material for the anode current collector is copper foil.

Cathode—An electrode capable of accepting lithium ions which generally comprise lithium oxide compounds, such as lithium iron phosphate, lithium carbonate, nickel manganese carbonate, and others as generally practiced in the industry. Others may use sulfur compounds, spinels, lithium manganese oxide, and others as are well known to those practiced in the art. Cathodes generally also have a current collector which in current practice is aluminum foil.

Electrolyte-A liquid in which lithium salts can be dissolved, which is used for transporting lithium ions from the anode to the cathode. Examples include ethylene carbonate, propylene carbonate, di-ethyl carbonate, dimethyl carbonate, mixtures of all of the above, and others. Electrolytes also may include additives, and specifically additives to help the formation of the SEI layer.

C-rate—The C-rate is determined by the current required to charge the cell to full capacity. 1 C is the rate in which the current required is sufficient to charge the cell to full capacity in one hour, generally taken by taking the cell capacity and dividing by one hour. Thus, for a 1 Ah cell, the 1 C charging rate is 1 Ampere. 2 C is twice this rate, and ½ C is half this rate.

### Microfiber and Nanofiber Production

As noted above, the microfiber may be constructed from any polymer (or polymer blend) that accords suitable chemical and heat resistance in conjunction with internal battery cell conditions, as well as the capability to form suitable fiber structures within the ranges indicated. Such fibers may further have the potential to be treated through a fibrillation or like technique to increase the surface area of the fibers themselves for entanglement facilitation during nonwoven fabrication. Such fibers may be made from longstanding fiber manufacturing methods such as melt spinning, wet spinning, solution spinning, melt blowing and others. In addition, such fibers may begin as bicomponent fibers and have their size and/or shape reduced or changed through further processing, such as splittable pie fibers, islands-in-the-sea fibers and others. Such fibers may be cut to an appropriate length for further processing, such lengths may be less than 50 mm, or less than 25 mm, or less than 12 mm even. Such fibers may be also be made long to impart superior processing or higher strength to have a length that is longer than 0.5 mm, longer than 1 mm, or even longer than 2 mm. Such fibers may also be fibrillated into smaller fibers or fibers that advantageously form wet-laid nonwoven fabrics.

Nanofibers for use in the current invention may be made through several longstanding techniques, such as islands-in-the-sea, centrifugal spinning, electrospinning, film or fiber fibrillation, and the like. Teijin and Hills both market potentially preferred islands-in-the-sea nanofibers (Teijin's is marketed as NanoFront fiber polyethylene terephthalate fibers with a diameter of 500 to 700 nm). Dienes and FiberRio are both marketing equipment which would provide nanofibers using the centrifugal spinning technique. Xanofi is marketing fibers and equipment to make them using a high shear liquid dispersion technique. Poly-aramids are produced by DuPont in nanofiber state that exhibit excellent high temperature resistance, as well as other particularly preferred properties.

Electrospinning nanofiber production is practiced by DuPont, E-Spin Technologies, or on equipment marketed for this purpose by Elmarco. Nanofibers fibrillated from films are disclosed in U.S. Pat. Nos. 6,110,588, 6,432,347 and 6,432,532, which are incorporated herein in their entirety by reference. Nanofibers fibrillated from other fibers may be done so under high shear, abrasive treatment. Nanofibers made from fibrillated cellulose and acrylic fibers are marketed by Engineered Fiber Technologies under the brand name EFTEC™. Any such nanofibers may also be further processed through cutting and high shear slurry processing to separate the fibers and enable them for wet laid nonwoven processing. Such high shear processing may or may not occur in the presence of the required microfibers.

Nanofibers that are made from fibrillation in general have a transverse aspect ratio that is different from those made initially as nanofibers in typical fashion (islands-in-the-sea, for instance). One such transverse aspect ratio is described in full in U.S. Pat. No. 6,110,588, which is incorporated herein by reference. As such, in one preferred embodiment, the nanofibers have a transverse aspect ratio of greater than 1.5:1, preferably greater than 3.0:1, more preferably greater than 5.0:1. As such, acrylic, polyester, cellulose and polyolefin fibers are particularly preferred for such a purpose, with fibrillated acrylic and cellulose fibers, potentially most preferred. Again, however, this is provided solely as an indication of a potentially preferred type of polymer for this purpose and is not intended to limit the scope of possible polymeric materials or polymeric blends for such a purpose.

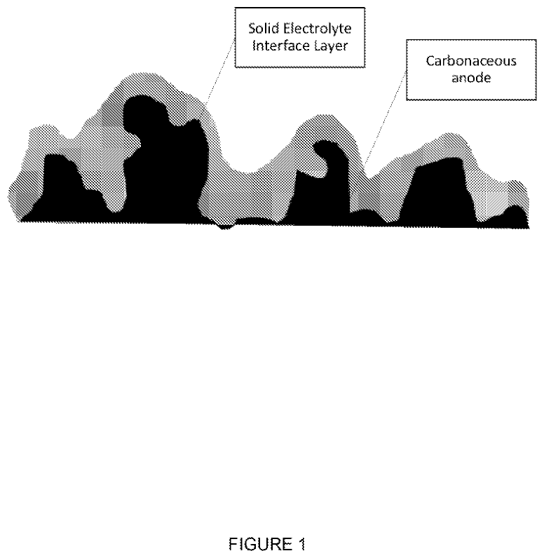

FIG. 1 provides a schematic representation of the solid electrolyte interface on the carbonaceous anode of a lithium-ion battery.

In all lithium-ion batteries, the electrolyte is unstable in the presence of the anode (carbonaceous). Because of this, the electrolyte degrades and forms a surface layer on the anode, called the solid electrolyte interface layer, which is formed of degraded and polymerized electrolyte on the surface of the anode. This layer prevents further decay of the electrolyte, and is conductive to lithium ions, so allows the functioning of the battery to charge and discharge continually.

With normal lithium-ion separators, which have a pore size of ˜0.01 microns, or 10 nm, the formation of the SEI layer proceeds slowly due to the slow movement of electrolyte to the anode surface. Thus the separator acts as a regulator for the SEI layer formation process.

In production, manufacturers will attempt to run this process as quickly as possible, using minimal current and lowest voltage to minimize the time and expense of the process and maximize the utilization of the equipment.

With nonwoven separators, which have a pore size that is larger than 10 nm, more on the order of 200-500 nm, the SEI layer formation is not governed by the pore size of the separator and proceeds faster. This creates a layer which is irregular and more open, and does not completely protect the anode, allowing further decay. It thus takes longer to form the SEI layer for nonwoven separators.

One issue is that if a “normal” formation process is used for lithium-ion batteries with a nonwoven separator, or any separator of high porosity and larger pore size, is that the SEI layer will not be completely formed, and areas of the anode will still be exposed to the electrolyte. If this happens, when the cell is taken off of formation (disconnected electrically), the SEI layer will continue to form, and this process will drain charge from the cell. This SEI layer formation continuation can be misinterpreted as a “soft short” within the cell, or lead to high self-discharge until the cell is properly formed.

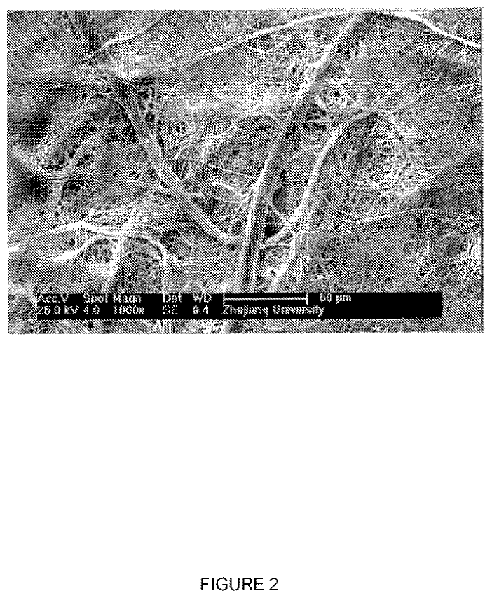

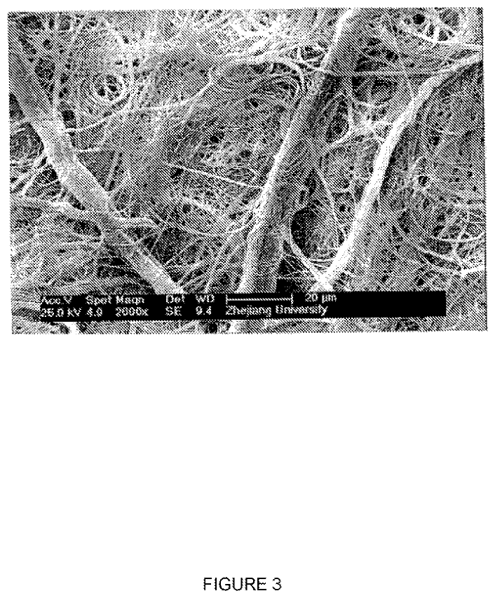

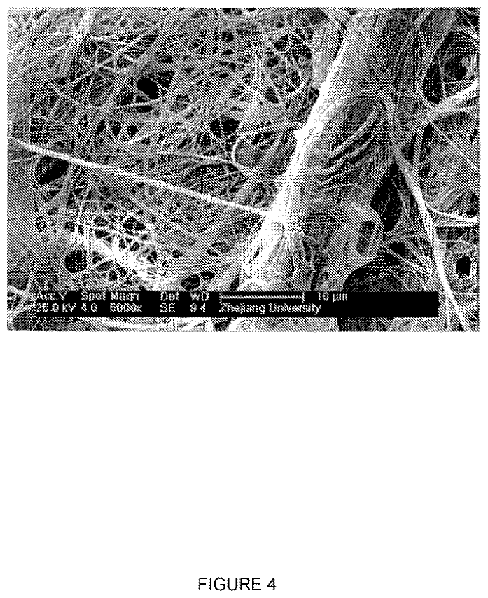

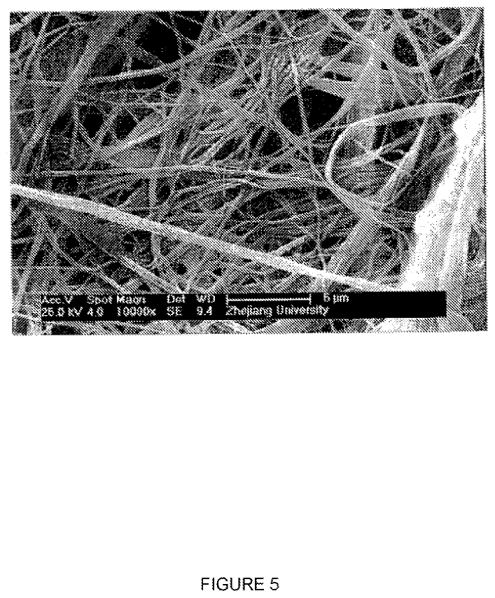

One potentially preferred embodiment of the initial combination of microfiber and nanofibers is the EFTEC™ A-010-4 fibrillated polyacrylonitrile fibers (FIGS. 2 and 3), which have high populations of nanofibers as well as residual microfibers. The resultant nanofibers present within such a combination are a result of the fibrillation of the initial microfibers. Nonwoven sheets made of these materials are shown in FIGS. 2 and 3. By way of example, these fibers can be used as a base material, to which can be added further microfibers or further nanofibers as a way of controlling the pore size and other properties of the nonwoven fabric, or such a material may be utilized as the nonwoven fabric battery separator itself. Examples of such sheets with additional microfibers added are shown in FIGS. 4 and 5. Typical properties of the acrylic Micro/Nanofibers are shown below in Table 1.

TABLE 1
Acrylic Micro/Nanofiber Properties

| | |
|---|---|
| Density, g/cm3 | 1.17 |
| Tensile Strength, MPa | 450 |
| Modulus, GPa | 6.0 |
| Elongation, % | 15 |
| Typical Fiber Length, mm | 4.5-6.5 |
| Canadian Standard Freeness, ml | 10-700 |
| BET Surface Area, m2/g | 50 |
| Moisture Regain, % | <2.0 |
| Surface Charge | Anionic |

Another potentially preferred embodiment of the initial combination of microfiber and nanofibers is the EFTEC™ L-010-4 fibrillated cellulose fibers (FIGS. 2 and 3), which have high populations of nanofibers as well as residual microfibers. The resultant nanofibers present within such a combination are a result of the fibrillation of the initial microfibers. By way of example, these fibers can be used as a base material, to which can be added further microfibers or further nanofibers as a way of controlling the pore size and other properties of the nonwoven fabric, or such a material may be utilized as the nonwoven fabric battery separator itself.

Such fibers are actually present, as discussed above, in a pulp-like formulation, thereby facilitating introduction within a wetlaid nonwoven fabric production scheme.

### Nonwoven Production Method

Material combinations can then be measured out to provide differing concentrations of both components prior to introduction together into a wet-laid manufacturing process. Handsheets can be made according to TAPPI Test Method T-205, which is incorporated here by reference (basically, as described above, mixing together in a very high aqueous solvent concentration formulation and under high shear conditions as are typically used in wet laid manufacturing and described as “refining” of fibers, ultimately laying the wet structure on a flat surface to allow for solvent evaporation).

The similarity in structure of the nonwoven fabrics of FIGS. 4 and 5 (larger microfibers and smaller nanofibers) are clarified, and the presence of fewer amounts of nanofibers in these structures is evident from these photomicrographs, as well.

The process for making and forming the cell, as outlined in Table 3, comprises steps of:
Drying the separator to eliminate residual water in an air oven, convection oven, forced air oven, vacuum oven or other oven known to those in the art. This step is less necessary and also limited in temperature for polyolefin separators. For nonwoven separator, residual water is present and can be eliminated in hand sheets with drying in an oven for 1 hour at 100° C. More preferably, this drying is for 3 hours, or most preferably for 12 hours. A more preferable temperature is 110° C., and most preferable 130° C. For material on rolls, the time and temperature required may depend on the size and put up of the roll, but in general 12 hours at 100° C. may be sufficient. However, 110° C. may be a more preferable drying temperature, and 130° C. most preferable. Additionally, 24 hours would be more preferable to eliminate residual moisture, with 48 hours most preferable.
Assembling the cells. This can be according to any procedure known to those in the art, and in any cell format. Procedures may include winding, stacking, laminating or other procedures. Cell formats may include cylindrical cells of various shapes and sizes well known in the art, and also polymer cells and prismatic cells also both of shapes and sizes well known in the art.
Drying Cells: In some instances to eliminate the last residual moisture from the anode, cathode and separator, the cell is dried, which may be in an air oven, convection oven, forced air oven, or vacuum oven. This may be done at 100° C. or higher temperature, preferably 110° C., most preferably 130° C.
Filling cells with electrolyte: Filling may be by any means to bring the electrolyte into the interior of the cell, and many methods are well known in the art. The electrolyte may be any lithium-ion battery electrolyte which generally comprises a mixture of organic solvents as well as a salt of lithium and a counterion. Examples of organic solvents include ethylene carbonate, methylene carbonate, diethyl carbonate, dimethyl carbonate, and propylene carbonate. An example of a lithium salt is LiPF₆. Alternatively, ionic liquids can be used and may provide advantages, including higher thermal stability and stability at higher voltages.
Formation: The assembled and filled cells must now go through an initial charge process to form the SEI layer and charge the cells. This formation will comprise various charging steps, which can be defined in terms of their current and voltage profile, and have been described above. This formation current and voltage profile may comprise pauses at various points in the charge profile which may be at constant voltage or floating voltage. The use of current is particularly important, such that specific parameters provide a sufficient solid electrolyte interface layer, such that an ideal current applied is not faster than C/4, preferably not faster than C/6, and more preferably not faster than C/10 (with C being the rate required to charge the cell to full capacity in one hour). Additionally, the use of voltage is very important, such that specific parameters provide a sufficient solid electrolyte interface layer, such that an ideal voltage is achieved at greater than 3.3 volts, preferably 3.6 volts, and more preferably 3.9 volts. Furthermore, the use of current to keep the voltage above 3.6 volts, such that a sufficient amount of time to apply the current is carried out at a time greater than six hours, preferably at a time greater than 9 hours, more preferably at a time greater than 12 hours. This process allows the SEI layer to form at a rate that is limited by current (not the pore size of the separator) and also allows a slow process at high voltage which will continue to fill in any gaps and give a uniform, complete coverage of the anode.

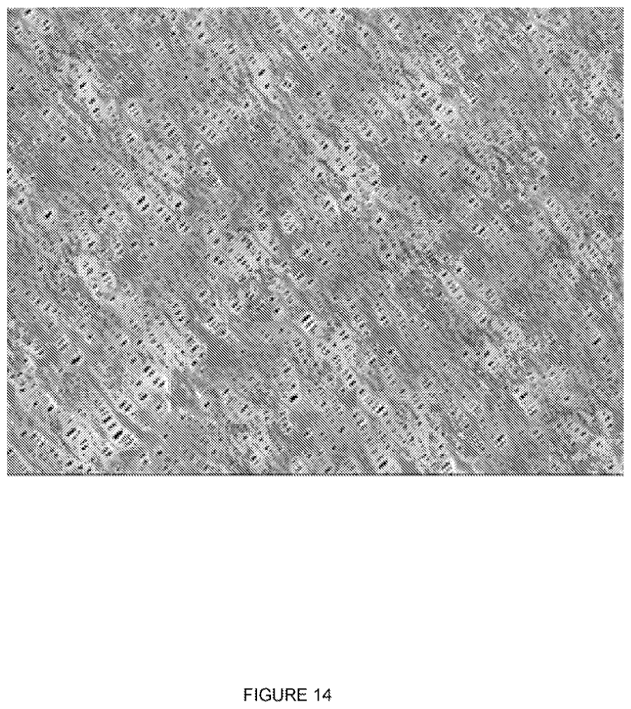

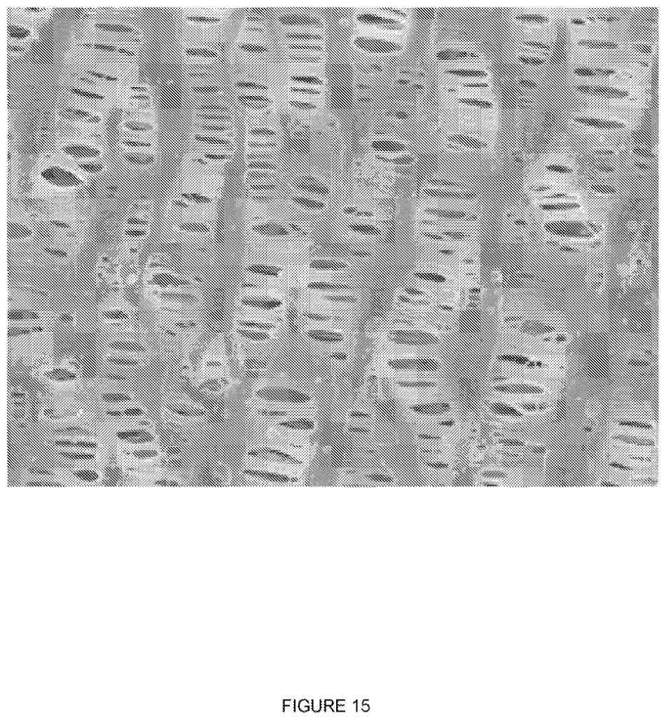

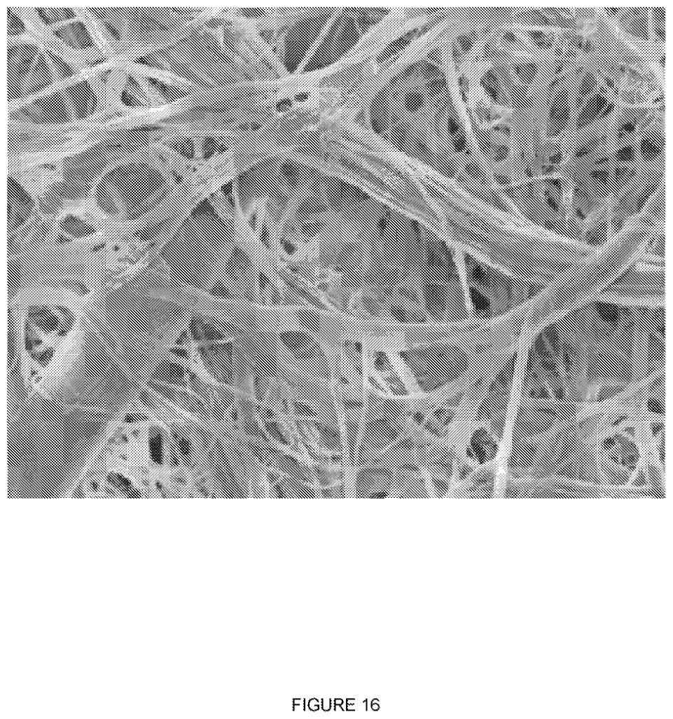

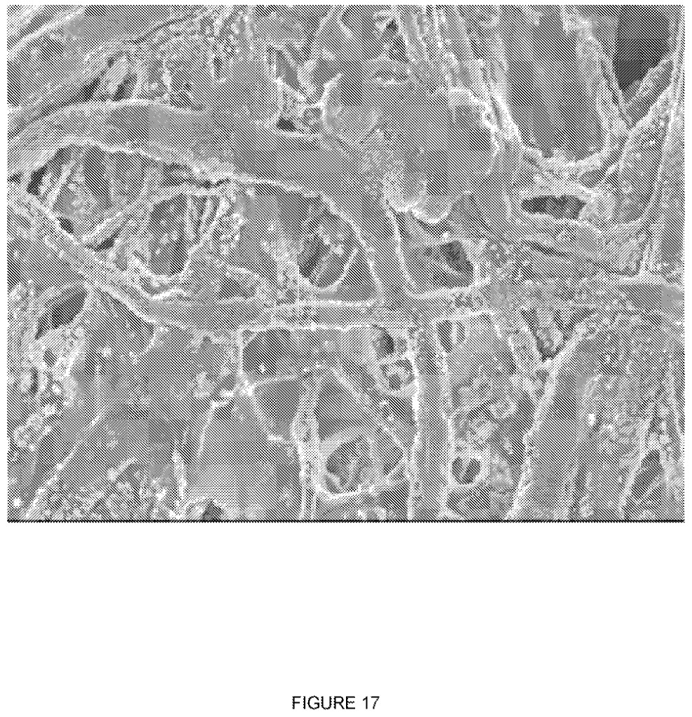

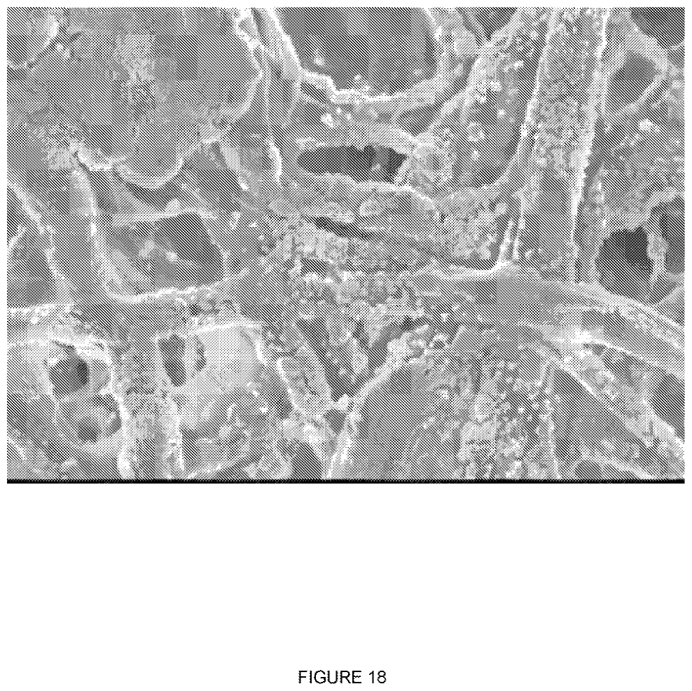

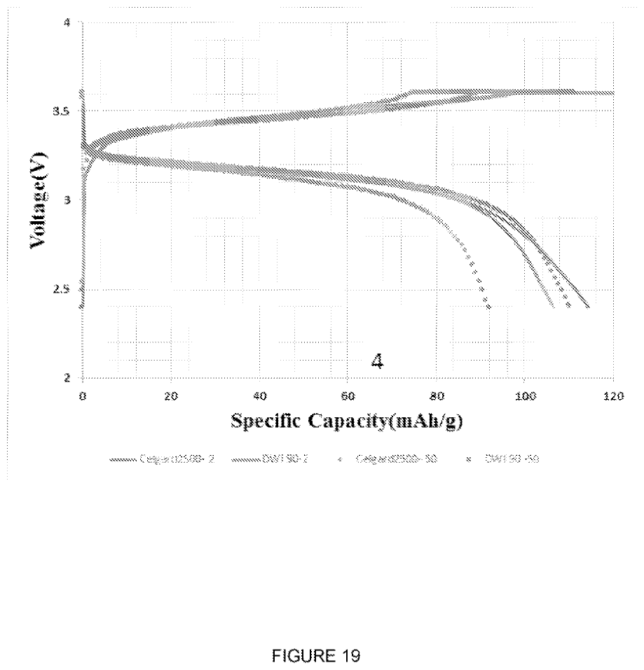

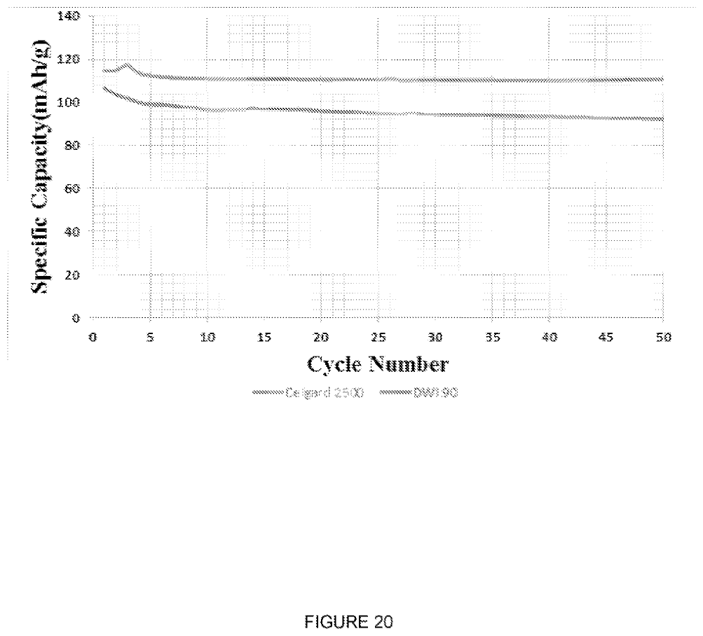

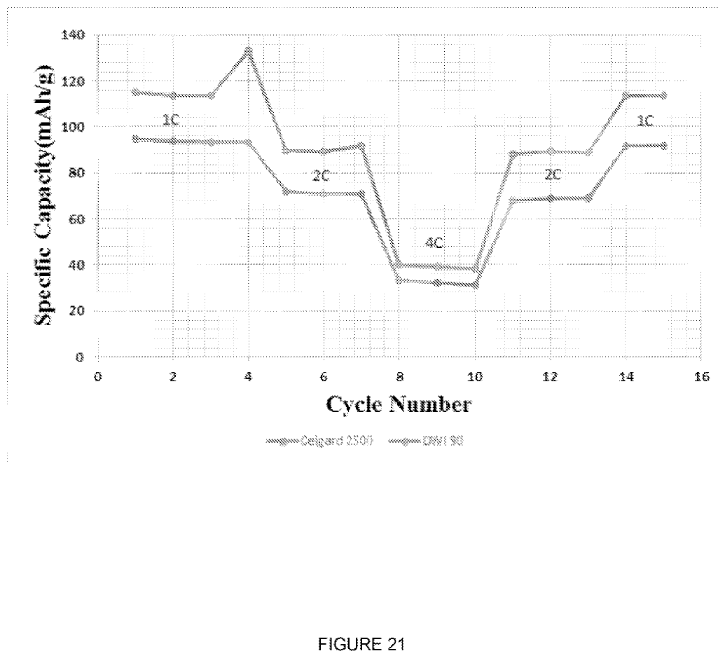

Cells formed under this process also differ in that the SEI layer has formed on the separator itself, rather than just the anode, which does not happen with prior art polyolefin separators. This can clearly be seen in the case of the prior art polyolefin separators in FIG. 14 and FIG. 15, which show a CELGARD® 2400 separator prior to inclusion in a cell, and after 29 cycles in an LFP cell. In the case of nonwoven separators, the SEI layer can be made under proper conditions to form on the separator itself, as can be seen in the difference between FIG. 16, which shows the separator before inclusion in the cell, and FIG. 17 and FIG. 18, which show the separator after 29 cycles in an LFP cell, and in which there is clear formation of the SEI layer on the separator. As shown in the charge discharge curves in FIG. 19, the cycle life in FIG. 20, and the rate capability in FIG. 21, even with the inclusion of the SEI layer in the separator itself, the conductivity of the separator and electrolyte and SEI layer is higher than with CELGARD® 2400 separator, resulting in higher discharge capacity, less decay on cycling, and higher rate capability.

The inclusion of an SEI layer on the separator may take a variety of forms. As such, such an SEI layer can be seen under SEM micrographs to comprise regions where substantially all of the pores present in SEM micrographs of the initial separator have been filled. The SEI layer may also comprise regions where nanofibers present in SEM micrographs of the initial separator are not observed to be present because they have been embedded in the SEI layer. Lithium-ion cell SEI layers are known to be made from decayed electrolyte, and so will contain the lithium salt used in their manufacture, containing high levels of fluorine and phosphorus, which may be measured by energy dispersive x-ray spectroscopy, or EDS. Such separators may comprise regions which have a phosphorus level as measured by EDS of greater than 1.5%, preferably greater than 2.0%, more preferably greater than 2.5%. Such separators may also comprise regions which have a fluorine level as measured by EDS of greater than 5%, preferably greater than 7%, more preferably greater than 9%.

### Examples

Dreamweaver Silver separator is made according to the process described in U.S. Pat. No. 8,936,878, which is hereby incorporated by reference. The examples used in these tests were Dreamweaver Silver 25, comprising EFTec A-010-04 nanofibrillated polyacrylonitrile fibers, EFTec L-010-04 nanofibrillated cellulose fibers, and polyethylene terephthalate fibers at 5 mm length and 0.3 denier per filament. The properties of this separator are shown in Table 2 below.

TABLE 2

| | Unit of | Dreamweaver |
|---|---|---|
| Basic Membrane Property | Measurement | Silver ™ 25 |
| Thickness (12.6 psi) | μm | 27 |
| Thickness (25 psi) | μm | 26 |
| Gurley (JIS) | seconds | 80 |
| Porosity | % | 56% |
| Pore Size | μm | 1.1 |
| TD Shrinkage @ 160° C. | % | 0 |
| MD Shrinkage @ 160° C. | % | 2 |
| TD Strength | Kgf/cm² | 175 |
| MD Strength | Kgf/cm² | 330 |
| Young's Modulus | Kgf/cm² | 23,000 |
| Melt Integrity | C. | 300 |
| Puncture Strength | g | 280 |
| Moisture Content | % | 3.7% |

The fabric was measured for thickness and then cut into suitable sizes and shapes for introduction within lithium-ion rechargeable battery cells. Prior to any such introduction, however, samples of the battery separator fabrics were analyzed and tested for various properties in relation to their capability as suitable battery separators. Furthermore, comparative examples of battery separator nanofiber membranes according to U.S. Pat. No. 7,112,389, which is hereby incorporated by reference, as well as battery separator films from CELGARD, are reported from the tests in the patent and from CELGARD product literature.

### Battery Separator Base Analysis and Testing

The test protocols were as follows:

Porosity was calculated according to the method in U.S. Pat. No. 7,112,389, which is hereby incorporated by reference. Results are reported in %, which related to the portion of the bulk of the separator that is filled with air or non-solid materials, such as electrolyte when in a battery.

Gurley Air Resistance was tested according to TAPPI Test Method T460, which is hereby incorporated by reference. The instrument used for this test is a Gurley Densometer Model 4110. To run the test, a sample is inserted and fixed within the densometer. The cylinder gradient is raised to the 100 cc (100 ml) line and then allowed to drop under its own weight. The time (in seconds) it takes for 100 cc of air to pass through the sample is recorded. Results are reported in seconds/100 cc, which is the time required for 100 cubic centimeters of air to pass through the separator.

Mean Flow Pore Size was tested according to ASTM E-1294 “Standard Test Method for Pore Size Characteristics of Membrane Filters Using Automated Liquid Porosimeter” which uses an automated bubble point method from ASTM F 316 using a capillary flow porosimeter. Tests were performed by Porous Materials, Inc., Ithaca, NY.

The air permeability of a separator is a measurement of the time required for a fixed volume of air to flow through a standard area under light pressure. The procedure is described in ASTM D-726-58.

### Experimental: Cell Manufacturer A

Production lithium iron phosphate electrodes were obtained from two manufacturers and tested in single layer pouch cells clamped between two pieces of plexiglass to give uniform pressure. In the cells, the electrical properties other than self-discharge were very consistent, and will be reported more completely elsewhere.

Single layer pouch cells were made of dimensions 50 mm×50 mm. The electrodes (matching anode and cathode pairs) were commercially produced by Chinese battery producers. The cells were filled with lithium-ion battery electrolyte comprising 1 mole LiPF₆ in a 4:3:3 volumetric mixture of ethylene carbonate, dimethyl carbonate and diethyl carbonate, sealed formed and tested according to the procedure and test parameters in Table 3, using the variables in Table 4 found below (specifically, charge rate, voltage, cutoff current, and number of cycles for the formation of the SEI layer, and drying temperature for the separator for each cell). Testing was done on a Neware battery tester using the procedures listed below.

The cell building process included separator drying, cell assembly and drying, electrolyte filling and formation, followed by a self-discharge test at 30% state of charge (SoC) and a final capacity test comprising a full charge and full discharge. Such test results are provided in Tables 3 and 4, below.

TABLE 3
Cell Cycle

Dry separator 3 hrs under vacuum at Drying T
Assemble cells
Dry cells overnight at 100° C.
Fill Cells with electrolyte, wait >2 hrs
Tap charge 20 2.00 V
CV @ 2.00 V 24 hrs
Sit 24 hours (rest)
Formation charge at CC rate to Voltage then CV to CV Cutoff
Discharge at CC Rate 20 2.5 V
2^{nd} Formation charge if included
2^{nd} Discharge if included
Charge cells at C/6 to 30% SoC
Record voltage (24 hour rest period)
Wait 14 days
Record voltage
Discharge at C/6 to 2.5 V
Charge cells at C/6 to 3.60 V, CV to C/60
Discharge Cells at C/6 to 2.50 V
Charge cells to 50% SoC at C/6
Ship cells to DWI

TABLE 4

| A Cell | B Cell | CC Rate | Voltage | CV Cutoff | # cycles | Drying T |
|---|---|---|---|---|---|---|
| A1 | B1 | C/6 | 3.6 | C/60 | 2 | 120 |
| A2 | B2 | C/6 | 3.6 | C/60 | 1 | 120 |
| A3 | B3 | C/6 | 3.6 | C/30 | 2 | 120 |
| A4 | B4 | C/6 | 3.6 | C/30 | 2 | 120 |
| A5 | B5 | C/3 | 3.6 | C/30 | 1 | 120 |
| A6 | B6 | C/6 | 3.4 | C/60 | 2 | 120 |
| A7 | B7 | C/6 | 3.6 | C/60 | 2 | 110 |
| A8 | B8 | C/6 | 3.6 | C/60 | 1 | 110 |
| A9 | B9 | C/6 | 3.6 | C/30 | 2 | 110 |
| A10 | B10 | C/3 | 3.6 | C/30 | 2 | 110 |
| A11 | B11 | C/3 | 3.6 | C/30 | 1 | 110 |
| A12 | B12 | C/6 | 3.4 | C/60 | 2 | 110 |

The results of formation of the cells made from electrodes from manufacturer A (found above) are shown below in Table 5. It is noted that each cell condition is the average of two cells.

TABLE 5

| | 1^{st} Cycle | | 2^{nd} Cycle | |
|---|---|---|---|---|
| | Coulombic | 1^{st} Cycle | Coulombic | 2^{nd} Cycle |
| Cell | Efficiency | Charge Time | Efficiency | Charge Time |
| A1 | 68% | 12:05:30 | 101.7% | 7:09 |
| A2 | 45% | 42:55:30 | | |
| A3 | 84% | 7:45:00 | 101.1% | 5:42 |
| A4 | 75% | 10:25:30 | 101.6% | 5:57 |
| A5 | 81% | 8:02:00 | | |
| A6 | 84% | 9:01:00 | 97.6% | 7:08 |
| A7 | 76% | 12:18:00 | 102.7% | 6:12 |
| A8 | 50% | 42:06:30 | | |
| A9 | 83% | 9:11:00 | 100.7% | 6:19 |
| A10 | 76% | 8:59:00 | 100.0% | 5:59 |
| A11 | 57% | 14:52:30 | | |
| A12 | 81% | 9:07:00 | 98.3% | 6:28 |

From these results, a few observations may be made. The coulombic efficiency for the first charge cycle is relatively low, ranging from 45% for condition A2 to 84% for conditions A3 and A6, with conditions A5, A9 and A12 all greater than 80%. The charge cycle time correlates with the coulombic efficiency, with a huge range from 8:02 hours to 42:55 hours. The extremely long times all occurred with cells having only a single charge (A2, A8, A11). The variation between cells in these pairs is very large, indicating potential experimental error. The coulombic efficiency for the 2nd cycle, where it was performed, is very close to 100% for all cells, ranging from 97.6% to 102.7%. The mean difference between pairs of cells was 0.75%. The charge time for the 2nd cycle is also relatively uniform, ranging only from 5:42 hours to 7:09. The average variation between pairs of cells was 0:30 hours, indicating a very tight correlation about the mean.

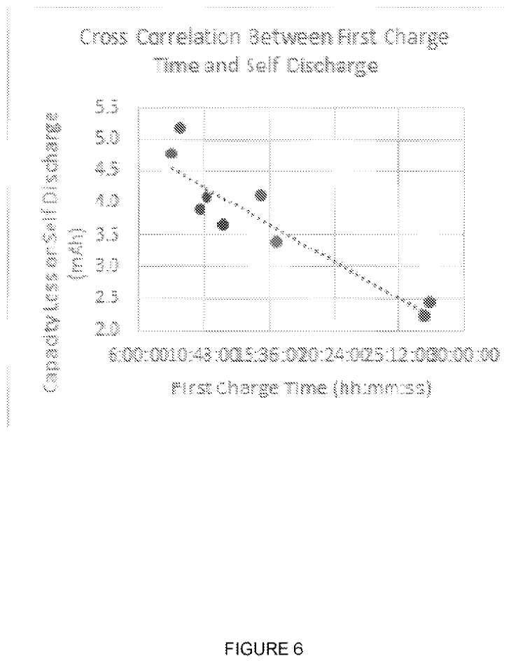

The results of the self-discharge testing, including the discharge after self-discharge, are included in Table 6 shown below as well as FIG. 6. It is again noted that each cell condition is the average of two cells.

TABLE 6

| | Self Discharge | | | | | Final |
|---|---|---|---|---|---|---|
| | | | | Residual | Loss | Discharge |
| Cell | Day 1 | Day 14 | Loss V | mAh | mAh | capacity |
| A1 | 3.293 | 3.263 | 0.030 | 14.1 | 3.9 | 55.4 |
| A2 | 3.295 | 3.281 | 0.014 | 15.7 | 2.3 | 57.0 |
| A3 | 3.298 | 3.258 | 0.040 | 13.5 | 4.5 | 54.6 |
| A4 | 3.290 | 3.258 | 0.032 | 14.0 | 4.0 | 56.1 |
| A5 | 3.295 | 3.268 | 0.027 | 13.6 | 4.4 | 52.8 |
| A6 | 3.292 | 3.264 | 0.028 | 12.2 | 5.8 | 50.5 |
| A7 | 3.290 | 3.264 | 0.026 | 14.6 | 3.4 | 54.9 |
| A8 | 3.297 | 3.280 | 0.017 | 17.8 | 0.2 | 56.5 |
| A9 | 3.285 | 3.252 | 0.033 | 13.0 | 5.0 | 58.9 |
| A10 | 3.288 | 3.254 | 0.034 | 12.9 | 5.1 | 56.7 |
| A11 | 3.295 | 3.267 | 0.029 | 15.9 | 2.1 | 55.6 |
| A12 | 3.294 | 3.266 | 0.029 | 13.4 | 4.6 | 51.4 |

Again, a few observations can be made. The range of self-discharge loss, both in voltage and in capacity, is quite high. For voltage, it ranges from a loss of 14 mV to 40 mV, and in capacity it ranges from 0.2 mAh to 5.8 mAh. It can be inferred from FIG. 6 that there is only a loose correlation between the final self-discharge voltage, the loss in voltage on self-discharge, and the loss in capacity on self-discharge. Furthermore, the range of final discharge capacity is high, but the correlation with process parameters is only slight. There is likely high experimental error due to both the small size of the electrodes and the potential for misalignment. There is not a high correlation between pairs, with an average variation in pairs of greater than 2 mAh.

### Data Analysis: Cell Manufacturer A

The data set was designed in a quasi-designed-experiment, which allows for averaging of partial sets to isolate a single variable and obtain a change in various measurements associated with that variable. These averages and the variables isolated are shown below in Table 7.

TABLE 7

| Variable | Group #1 | Group #2 |
|---|---|---|
| Drying Temperature | A1, A2, A3, A4, | A7, A8, A9, A10, |
| | A5, A6 | A11, A12 |
| Constant Charge Rate | A1, A2, A7, A8 | A4, A5, A10, A11 |
| Constant Voltage | A1, A7 | A3, A9 |
| Current Cutoff | | |
| Charge Voltage Cutoff | A1, A7 | A6, A12 |
| # Cycles | A2, A5, A8, A11 | A1, A4, A7, A10 |

Averaging the data among each of these groups allows the variable to be isolated among the largest group of samples, averaging out experimental error, and also identify first level cross correlations. In each case, the minimum number of cells averaged is eight (for Constant Voltage Current Cutoff and Charge Voltage Cutoff). The averages obtained for each measurement are shown below in Table 8 (Effcy below is Efficiency).

TABLE 8

| | | | | | | | | Final | Final |
|---|---|---|---|---|---|---|---|---|---|
| C1 | C1 | C2 | C2 | Self Discharge | | | | Charge | Discharge |
| Effcy | Time | Effcy | Time | Day 1 | Day 14 | Loss V | Loss mAh | capacity | capacity |

Drying Temp

| | | | | | | | | | | |
|---|---|---|---|---|---|---|---|---|---|---|
| 110° C. | 71% | 16:05:40 | 100.4% | 6:14 | 3.291 | 3.264 | 0.028 | 3.4 | 56.1 | 55.7 |
| 120° C. | 73% | 15:02:25 | 100.3% | 6:29 | 3.294 | 3.265 | 0.029 | 4.1 | 56.0 | 54.4 |

CC Rate

| | | | | | | | | | | |
|---|---|---|---|---|---|---|---|---|---|---|
| C/6 | 60% | 27:21:23 | 102.2% | 6:41 | 3.294 | 3.272 | 0.022 | 2.4 | 56.4 | 56.0 |
| C/3 | 72% | 10:34:45 | 100.8% | 5:58 | 3.292 | 3.261 | 0.030 | 3.9 | 55.8 | 55.3 |

CV Cutoff

| | | | | | | | | | | |
|---|---|---|---|---|---|---|---|---|---|---|
| C/60 | 72% | 12:11:45 | 102.2% | 6:41 | 3.291 | 3.263 | 0.028 | 3.7 | 55.7 | 55.1 |
| C/30 | 84% | 8:28:00 | 100.4% | 6:00 | 3.292 | 3.255 | 0.037 | 4.8 | 57.2 | 56.8 |

Voltage

| | | | | | | | | | | |
|---|---|---|---|---|---|---|---|---|---|---|
| 3.6 | 72% | 12:11:45 | 102.2% | 6:41 | 3.291 | 3.263 | 0.028 | 3.7 | 55.7 | 55.1 |
| 3.4 | 83% | 9:04:00 | 97.7% | 6:48 | 3.293 | 3.265 | 0.028 | 5.2 | 54.6 | 51.0 |

Cycles

| | | | | | | | | | |
|---|---|---|---|---|---|---|---|---|---|
| 1 | 59% | 26:59:08 | | 3.295 | 3.274 | 0.022 | 2.2 | 55.9 | 55.5 |
| 2 | 74% | 10:57:00 | 6:19 | 3.290 | 3.259 | 0.031 | 4.1 | 56.1 | 55.8 |

This data can tell an individual if a result (cell in the table) is changed by a variable (left most column of the table). Among the results, two are of importance to the user of a cell as performance criteria. The first of these is the self-discharge, which we will identify with the Self Discharge Loss mAh, the actual capacity lost during the 14 day hold period. The second is the Final Discharge Capacity, which can be taken as the initial capacity of the cell as it would be ready to be sold. For charge capacity, some conclusions can be drawn.

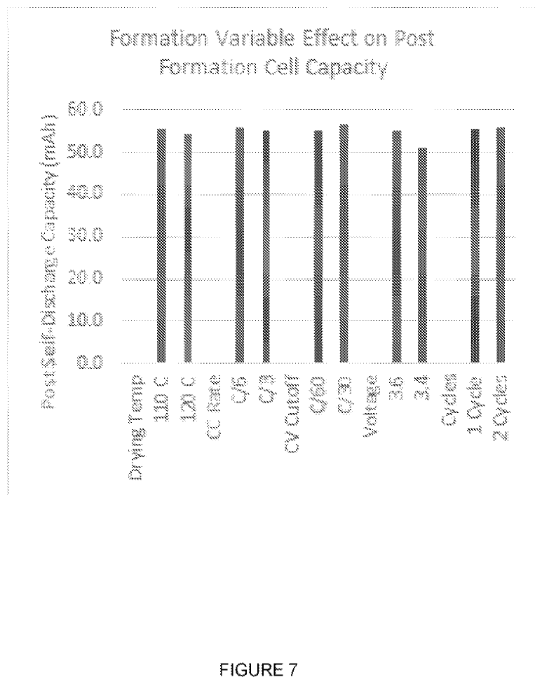

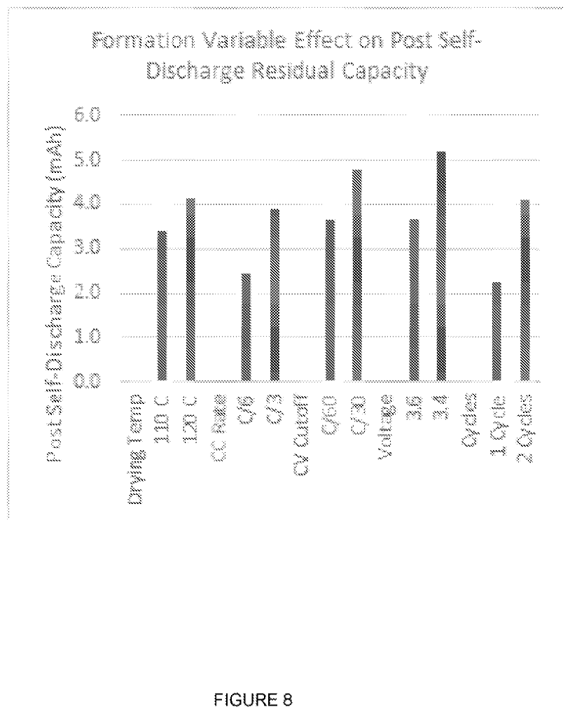

The Final Discharge Capacity is affected positively by lower drying temperature and higher charge cutoff voltage, each of which affects the capacity by 3-4 mAh, or 5-7%. These relations are shown in FIG. 7. Furthermore, the Self Discharge Loss (mAh) is affected positively (lower) by more variables as shown in FIG. 8, including lower drying temperature, lower constant current charging rate, lower constant current cutoff current, higher charging voltage, and fewer cycles (this appears to be an experimental anomaly, as the coulombic efficiencies for these cells do not correlate with the coulombic efficiencies of the first cycle of cells that undergo two cycles). These results are one basis for this invention, which includes a formation cycle using low current, high voltage, and a long soak at high voltage in this case corresponding to the low constant current cutoff current.

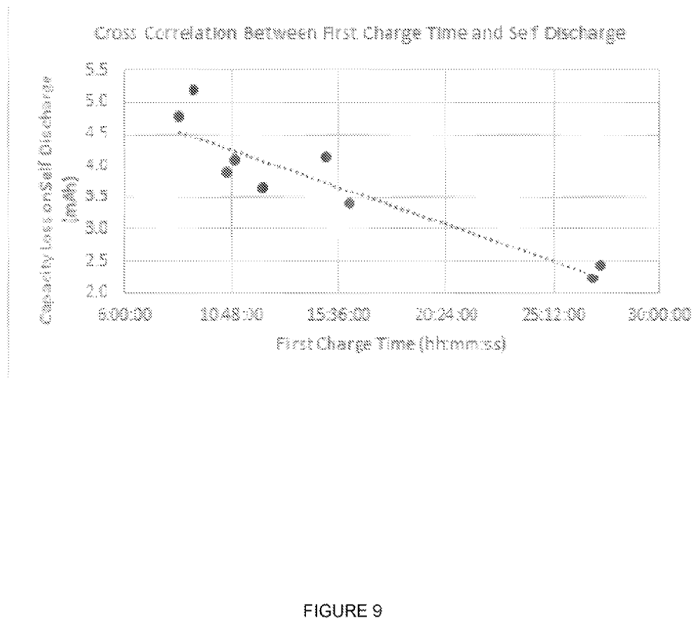

FIG. 9 is a table displaying the cross correlation between first charge time and self-discharge in lithium-ion batteries. The strongest correlation is between the total time spent in the first charge cycle and the self-discharge residual capacity after 14 days on open cell, which is shown in the chart to the right. Based on formation conditions, the capacity loss can be reduced by over 50%, from 5 mV to under 2.5 mV (the cells were charged to 18 mV, or 30% SOC prior to self-discharge). It can generally be seen that there appears to be a strong correlation with using longer initial charge times to reduce the self-discharge at the end of formation, independent of the variables used to achieve the higher charge time.

### Experimental: Cell Manufacturer B

The results of formation of the cells made from electrodes from Manufacturer B are shown below in Table 9. Each cell condition is the average of two cells.

TABLE 9

| | 1^{st} Cycle | | 2^{nd} Cycle | |
|---|---|---|---|---|
| | Coulombic | | Coulombic | |
| Cell | Efficiency | Charge Time | Efficiency | Charge Time |
| B1 | 53% | 17:16:00 | 99.7% | 7:10 |
| B2 | 82% | 9:04:30 | | |
| B3 | 35% | 22:11:00 | 99.2% | 6:34 |
| B4 | 46% | 15:16:30 | 100.7% | 6:51 |
| B5 | 34% | 24:44:00 | | |
| B6 | 82% | 14:13:30 | 100.0% | 7:18 |
| B7 | 41% | 30:34:30 | 75.5% | 13:33 |
| B8 | 60% | 14:58:30 | | |
| B9 | 17% | 45:29:30 | 99.4% | 7:19 |
| B10 | 56% | 18:32:30 | 75.5% | 10:03 |
| B11 | 84% | 8:46:00 | | |
| B12 | 85% | 10:50:00 | 98.8% | 7:56 |

From these results, a few observations may be made, which are very similar to those for Manufacturer A. The coulombic efficiency for the first charge cycle is relatively low, ranging from 13% for condition B8 to 85% for conditions B12, with conditions B2, B6 and B11 all greater than 80%. The charge cycle time correlates with the coulombic efficiency, with a huge range from 8:46 hours to 45:29 hours. There does not appear to be a correlation between the long charge times and formation conditions, different from Manufacturer A. Some of the pairs had good consistency, while others had wide variation, indicating intermittent experimental error. The coulombic efficiency for the 2nd cycle, where it was performed, is very close to 100% for all cells except two (B7-2, E10-1) ranging from 98.8% to 100.7%. The charge time for the 2nd cycle is also relatively uniform, ranging only from 6:34 hours to 13:33.

The results of the self-discharge testing, including the discharge after self-discharge, are included in Table 10. Again, each cell condition is the average of two cells.

TABLE 10

| | Self Discharge | | | | | Final |
|---|---|---|---|---|---|---|
| | | | | Residual | Loss | Discharge |
| Cell | Day 1 | Day 14 | Loss V | mAh | mAh | capacity |
| B1 | 3.291 | 3.249 | 0.042 | 13.7 | 4.3 | 58.0 |
| B2 | 3.290 | 3.239 | 0.051 | 11.8 | 6.2 | 57.0 |
| B3 | 3.300 | 3.254 | 0.046 | 12.5 | 5.5 | 57.3 |
| B4 | 3.295 | 3.248 | 0.037 | 12.4 | 5.6 | 60.6 |
| B5 | 3.299 | 3.262 | 0.037 | 15.1 | 2.9 | 62.1 |
| B6 | 3.295 | 3.248 | 0.043 | 12.1 | 5.9 | 63.5 |
| B7 | 3.295 | 3.256 | 0.039 | 13.8 | 4.2 | 61.8 |
| B8 | 3.295 | 3.254 | 0.042 | 13.4 | 4.6 | 62.6 |
| B9 | 3.292 | 3.251 | 0.041 | 12.6 | 5.4 | 66.3 |
| B10 | 3.282 | 3.246 | 0.037 | 12.3 | 5.7 | 61.6 |
| B11 | 3.280 | 3.227 | 0.053 | 10.3 | 7.7 | 63.3 |
| B12 | 3.287 | 3.249 | 0.039 | 12.1 | 5.9 | 55.1 |

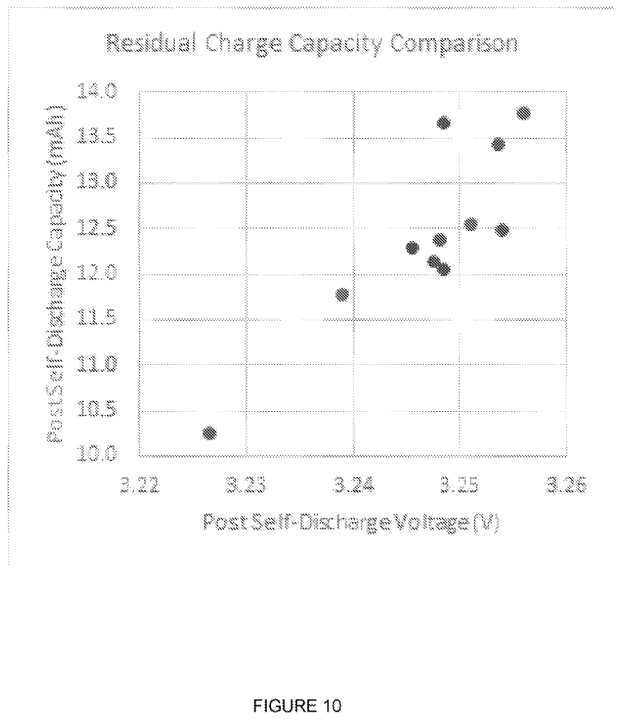

Again, a few observations can be made. The range of self-discharge loss, both in voltage and in capacity, is quite high. For voltage, it ranges from a loss of 37 mV to 86 mV, and in capacity it ranges from 2.9 mAh to 7.7 mAh. There is good correlation between the final self-discharge voltage, the loss in voltage on self-discharge and the loss in capacity on self-discharge (see FIG. 10). The range of final discharge capacity is high, but the correlation with process parameters is only slight. There is likely high experimental error here due both to the small size of the electrodes and the potential for misalignment. There is not a high correlation between pairs, with an average variation in pairs of greater than 2 mAh.

### Data Analysis: Cell Manufacturer B

The data was averaged among the same groups as for Manufacturer B. The averages obtained for each measurement are shown below in Table 11.

TABLE 11

| | | | | | | | | Final | Final |
|---|---|---|---|---|---|---|---|---|---|
| C1 | C1 | C2 | C2 | Self Discharge | | | | Charge | Discharge |
| Effcy | Time | Effcy | Time | Day 1 | Day 14 | Loss V | Loss mAh | capacity | capacity |

Drying Temp

| | | | | | | | | | | |
|---|---|---|---|---|---|---|---|---|---|---|
| 110° C. | 57% | 21:31:50 | 87.3% | 9:43 | 3.288 | 3.247 | 0.041 | 5.6 | 61.3 | 60.3 |
| 120° C. | 57% | 16:40:00 | 100.0% | 7:02 | 3.310 | 3.220 | 0.091 | 6.4 | 60.2 | 59.1 |

CC Rate

| | | | | | | | | | | |
|---|---|---|---|---|---|---|---|---|---|---|
| C/6 | 65% | 17:49:37 | 94% | 9:00 | 3.291 | 3.249 | 0.037 | 5.1 | 61.0 | 59.9 |
| C/3 | 55% | 16:49:45 | 88% | 8:27 | 3.294 | 3.190 | 0.103 | 7.1 | 61.8 | 60.8 |

CV Cutoff

| | | | | | | | | | | |
|---|---|---|---|---|---|---|---|---|---|---|
| C/60 | 47% | 23:55:15 | 88% | 10:21 | 3.293 | 3.252 | 0.041 | 4.3 | 60.6 | 59.6 |
| C/30 | 23% | 37:43:20 | 99% | 8:27 | 3.335 | 3.272 | 0.063 | 5.5 | 62.1 | 61.2 |

Voltage

| | | | | | | | | | | |
|---|---|---|---|---|---|---|---|---|---|---|
| 3.6 | 54% | 23:22:30 | 89% | 10:18 | 3.294 | 3.254 | 0.030 | 4.3 | 60.6 | 59.6 |
| 3.4 | 83% | 12:31:45 | 99% | 7:37 | 3.289 | 3.248 | 0.041 | 5.9 | 59.3 | 57.8 |

Cycles

| | | | | | | | | | | |
|---|---|---|---|---|---|---|---|---|---|---|
| 1 | 65% | 14:23:15 | | | 3.296 | 3.190 | 0.106 | 7.0 | 61.1 | 60.2 |
| 2 | 49% | 20:24:52 | 88% | 9:24 | 3.291 | 3.250 | 0.041 | 5.1 | 60.8 | 59.9 |

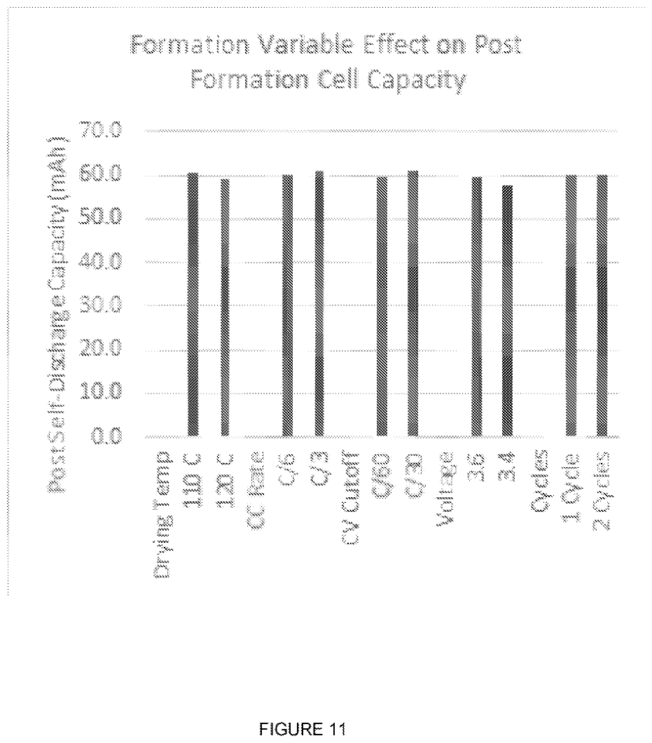

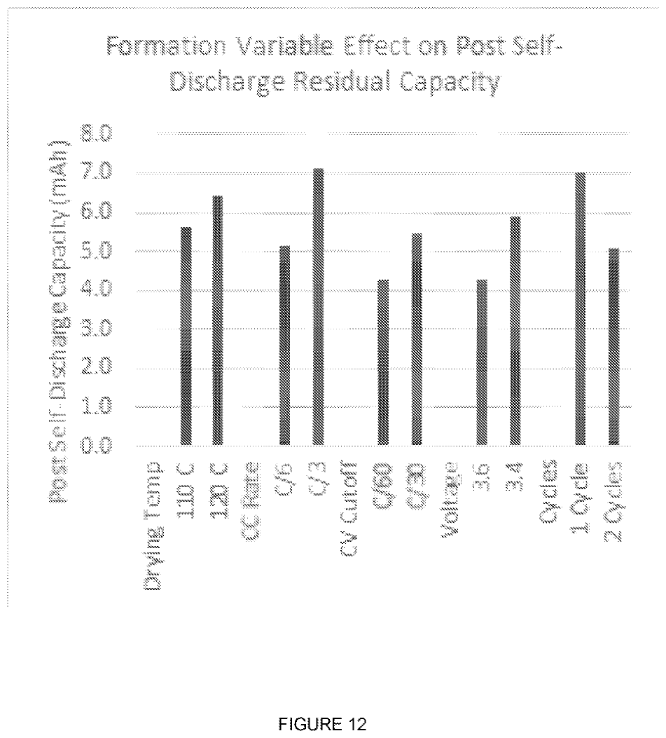

Looking at the data in the same was as for Manufacturer A, some conclusions can be drawn. The Final Discharge Capacity is very consistent, and really only affected by the charge voltage. These relations are shown in FIG. 11. The Self Discharge Loss (mAh) is affected positively (lower) by more variables as shown in FIG. 12, including lower drying temperature, lower constant current charging rate, lower constant current cutoff current, higher charging voltage, and more cycles. Again, these results support the conclusion that a slow charge to high voltage with a long soak at high voltage provides for a battery with superior properties.

Especially for self-discharge, the correlations are the same as for Manufacturer A except for the number of cycles, which for Manufacturer A appeared to be an experimental anomaly due to an inconsistency in the first cycle coulombic efficiency between cells with one cycle formation versus two cycle. The cells for Manufacturer B did not have this inconsistency, and so the conclusion is the more cycles will reduce the self-discharge, which agrees with the general behavior that has been seen in multiple other cell build.

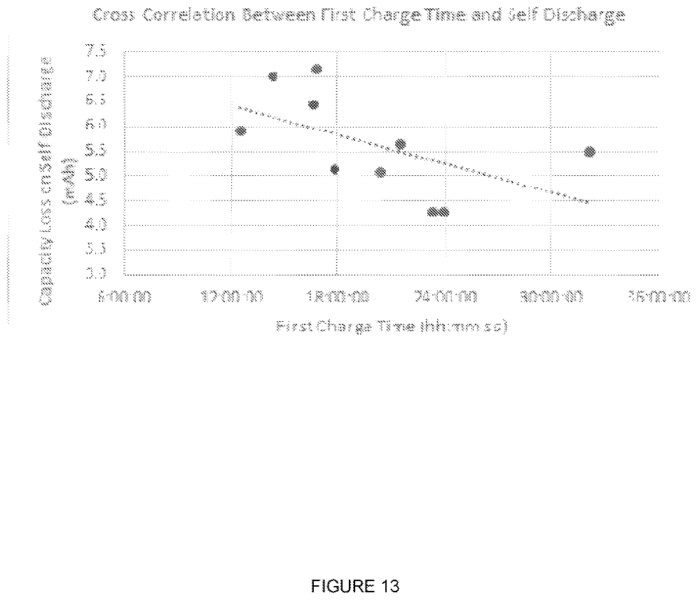

As with Manufacturer A, there is one significant cross correlation, between the C1 Time and the Self Discharge Loss, which is shown below in FIG. 13. As can be seen, it appears there is a strong correlation with using longer initial charge times to reduce the self-discharge at the end of formation, independent of the variables used to achieve the higher charge time.

Several strong correlations were shown between the formation parameters and the self-discharge and cell capacity achieved. While every cell should be optimized on its own and these results may not correlate with other cells, based on these results, the following recommendations will likely result in an improvement in cell capacity of up to 5% and a reduction of self-discharge rates of up to 50%.

Based on the results, it is recommended that, in specific embodiments, the Dreamweaver Silver separator is dried at a maximum separator drying temperature of 110 degrees Celsius. It is further recommended that the formation of the SEI layer utilize a low initial charge cycle current at a maximum of C/6 up until the cell is partially charged and a higher charge at C/6 after the cell is partially charged. It is further recommended that the formation proceed to at least 3.6 volts, or even as high as 4.0 volts or higher for some cathode systems. It is further recommended that the formation include a high voltage CV (constant voltage) charge either until a low current is achieved (less than C/60) or for a specified period of time (greater than six hours).

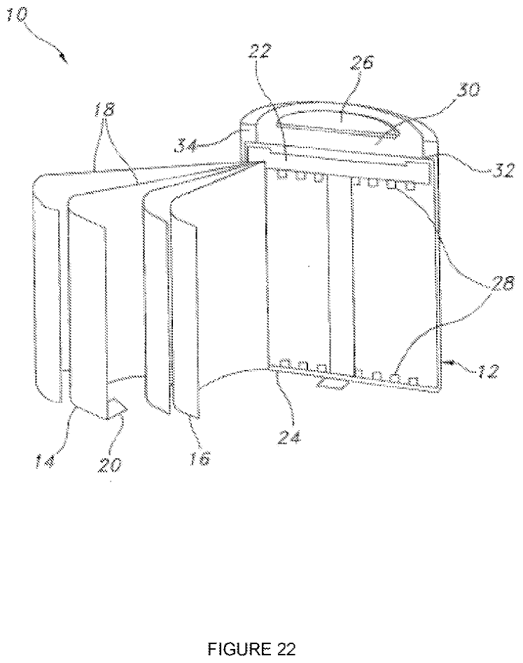

FIG. 22 shows the typical battery 10 structure with the outside housing 12 which includes all of the other components and being securely sealed to prevent environmental contamination into the cell as well as any leakage of electrolyte from the cell. An anode 14 is thus supplied in tandem with a cathode 16, with at least one battery separator 18 between the two. An electrolyte 20 is added to the cell prior to sealing to provide the necessary ion generation. The separator 18 thus aids in preventing contact of the anode 14 and cathode 16, as well as to allow for selected ion migration from the electrolyte 20 therethrough. The general format of a battery cell follows this structural description, albeit with differing structures sizes and configurations for each internal component, depending on the size and structure of the battery cell itself. In this situation, button battery of substantially circular solid components were produced for proper testing of separator effectiveness within such a cell.

To that end, coin cells were then produced to allow teardown and measurement of the separator after teardown. CR2032 coin cells were assembled. LFP and graphite electrode were the commercial electrodes used from Manufacturer B above, and 1.0 M LiPF₆ solution in a mixture of ethylene carbonate and diethyl carbonate (EC/DEC 1:1 in volume) was used as electrolyte. CELGARD 2400 separator was used after drying at 60° C. For the DWI Silver Separator, cells were made with non-dried separator as well as separator dried for 4 hours at 90° C. and 120° C. After cell assembly, the cells were kept under vacuum at 50° C. overnight for stabilization. After stabilization, cells were cycled (CCCV) on Toyo battery cycler. Initially, cells were cycled for 2 formation cycles, followed by rate capability testing at 1 C, 2 C, 4 C, 2 C (3 cycles each). After rate capability, cells were cycled for 50 cycles at 1 C rate. The results of these cycle tests are shown as charge discharge curves in FIG. 19, as cycle life in FIG. 20, and as rate 825 capability in FIG. 21.

As shown in FIG. 20, such a battery with a pre-formed SEI layer therein with an enmeshed microfiber/nanofiber separator (DWI Silver 25, for example) present throughout such SEI formation and having an ethylene carbonate/diethylene carbonate and LiPF₆ electrolyte therein, exhibits, after cycling a specific capacity of at least 38 mAh/g throughout the 1 C, 2 C, 4 C, 2 C, and 1 C cycles. In comparison, the CELGARD 2500 separator type battery (with the same electrolyte and overall construction) exhibited far lower specific capacity measures over the same cycles. Likewise, FIG. 21 shows s different measurement of specific capacity for the inventive battery and the comparative CELGARD type. Over 50 continuous cycles from initial charge, the pre-formed SEI layer batteries exhibited starkly different results. The inventive battery, having the same electrolyte as above, exhibited a specific capacity in excess of 100 mAh/g over such a continuous 50 cycles. Noticeably, the comparative battery was well below such a number, indicating greater reliability for the inventive type, presumably due to the effective pre-formation of an SEI layer over the anode as well as the battery separator.

To show the overall results of the pre-formed SEI layer within the subject batteries (inventive and comparative), certain examples were then effectively subject to teardown to determine the overall SEI layer coverage therein and thereon the separators themselves. Thus. after completion of cycling, example coin cells were torn down in an Argon-filled glove box and were dried under vacuum before SEM and EDX analysis. Samples for SEM and EDX analysis were prepared and coated with gold/palladium. For SEM analysis Carl Zeiss Auriga-BU FIB FESEM Microscope was used. For EDX analysis the Scanning Electron Microscope with Energy Dispersive Spectrometer (Bruker Nano with XFlash Detector 5030) was used. EDX performed on the separators resulted in the atomic peaks as shown in Table 12.

TABLE 12

| Element | CELGARD 2500 | DWI Silver 25 |
|---|---|---|
| Carbon | 88.05 | 68.48 |
| Oxygen | 6.81 | 16.30 |
| Fluorine | 3.99 | 12.23 |
| Phosphorus | 1.15 | 3.00 |

These measurements show that the SEI layer if far more developed on the inventive separator than on the comparative film separator. A measurement of a Carbon atomic peak of at most 70, in this instance, an Oxygen atomic peak of at least 8, a Fluorine atomic peak of at least 5, and a Phosphorus atomic peak of at least 1.5, is thus of importance in this situation to provide a mature SEI layer within the battery. Such an SEI layer accords, as noted above, greater reliability for initial charge and cycling, particularly within the layer present on the anode and the separator together. Thus, with such an effective SEI layer result, and a separator that lends itself to such coverage during cycling and initial charging, at least, the batteries made therefrom exhibit, as noted above, excellent initial capacity, providing, as well, greater reliability during use and potentially longer shelf-life while awaiting such an initial charge within a subject device (cell phone, etc., as examples).

An example method comprises the steps of assembling a cell including an interior volume comprising an anode, a cathode, and a separator; filling the interior volume of the cell with an electrolyte; connecting the anode and the cathode to a charging device; charging the cell at a rate less than or equal to C/6 until the cell reaches a voltage capacity; and charging the cell at a voltage higher than a set voltage for greater than six hours. The invention further encompasses such a method wherein the voltage for termination of the low rate charging step is greater than or equal to 3.4 volts. The invention further encompasses such a method wherein the voltage for the high voltage charging step is greater than 3.4 volts.

Embodiments may include specific parameters that provide a sufficient solid electrolyte interface layer, such that an ideal current applied is not faster than C/4, preferably not faster than C/6, and more preferably not faster than C/10 (with C being the rate required to charge the cell to full capacity in one hour). Additionally, the use of voltage is very important, such that specific parameters provide a sufficient solid electrolyte interface layer, such that an ideal voltage is achieved at greater than 3.3 volts, preferably 3.6 volts, and more preferably 3.9 volts. Furthermore, the use of current to keep the voltage above 3.6 volts, such that a sufficient amount of time to apply the current is carried out at a time greater than six hours, preferably at a time greater than 9 hours, more preferably at a time greater than 12 hours. This process allows the SEI layer to form at a rate that is limited by current (not the pore size of the separator) and also allows a slow process at high voltage which will continue to fill in any gaps and give a uniform, complete coverage of the anode. As noted above, such anode coverage is of importance for overall battery reliability (and extended shelf-life, presumably, prior to initial charge).

While this disclosure has been particularly shown and described with reference to preferred embodiments thereof and to the accompanying drawings, it will be understood by those skilled in the art that various changes in form and details may be made therein without departing from the spirit of this disclosure. Therefore, the scope of the disclosure is defined not by the detailed description but by the appended claims.

1. A lithium-ion battery including a cathode, an anode, a separator comprising pores, and a liquid electrolyte therein, said battery including a solid electrolyte interface (SEI) layer on said separator thereof, and having undertaken an initial charge after manufacture thereof, wherein said battery exhibits a specific capacity in excess of 100 mAH/g for 50 continuous cycles subsequent to said initial charge.

2. The battery of claim 1 wherein said separator comprises randomly oriented fibers.

3. The battery of claim 2 wherein said separator comprises enmeshed microfibers and nanofibers.

4. The battery of claim 3 wherein said separator exhibits a mean flow pore size greater than or equal to 0.1 microns.

5. The battery of claim 1 wherein said SEI layer fills substantially all of said pores of said separator in at least discrete regions thereof under SEM micrograph analysis thereof.

6. The battery of claim 3 wherein said nanofibers of said separator are embedded within said SEI layer in at least discrete regions of said separator.

7. The battery of claim 1 wherein said SEI layer comprises regions observed under energy dispersive x-ray spectroscopy (EDS) to exhibit phosphorus levels of greater than 2.5%.

8. The battery of claim 7 wherein said observed phosphorus levels of said SEI layer is greater than 1.5%.

9. The battery of claim 1 wherein said SEI layer comprises regions observed under energy dispersive x-ray spectroscopy (EDS) to exhibit fluorine levels of greater than 9%.

10. The battery of claim 9 wherein said observed fluorine levels of said SEI layer is greater than 5%.

11. A lithium-ion battery including a cathode, an anode, a separator comprising pores, and an electrolyte therein, said battery including a solid electrolyte interface (SEI) layer on the separator thereof, and having undertaken an initial charge after manufacture thereof, wherein said battery exhibits a specific capacity of at least 38 mAH/g for throughout 16 cycles from 1 C, 2 C, 4 C, 2 C, and 1 C, subsequent to said initial charge.

12. The battery of claim 11 wherein said separator comprises randomly oriented fibers.

13. The battery of claim 12 wherein said separator comprises enmeshed microfibers and nanofibers.

14. The battery of claim 13 wherein said separator exhibits a mean flow pore size greater than or equal to 0.1 microns.

15. A LiPF₆ battery including a cathode, an anode, a separator comprising pores, and a liquid electrolyte therein, said battery including a solid electrolyte interface (SEI) layer present on both the anode and separator thereof, wherein said separator exhibits a SEI measurement in atomic peaks under a scanning electron microscope of at most 70 carbon, at least 8 Oxygen, at least 5 Fluorine, and at least 1.5 Phosphorus.

16. The battery of claim 15 wherein said separator comprises randomly oriented fibers.

17. The battery of claim 16 wherein said separator comprises enmeshed microfibers and nanofibers.

18. The battery of claim 17 wherein said separator exhibits a mean flow pore size greater than or equal to 0.1 microns.

19. A method of producing a lithium-ion battery, the method comprising the steps of:
assembling a cell including an interior volume comprising an anode, a cathode, and a nonwoven separator having a pore size of larger than 10 nm and having randomly oriented fibers comprising enmeshed microfibers and nanofibers;
filling the interior volume of said cell with a lithium-ion battery electrolyte including LiPF₆;
connecting the anode and the cathode to a charging device;
initially charging said cell at a C-rate less than or equal to C/10 until said the cell reaches a termination voltage;
and
thereafter charging said cell at a constant voltage of at least 3.4 volts for greater than 6 hours;
wherein, subsequent to both of said charging steps, said battery exhibits a solid electrolyte interface (SEI) layer on said separator thereof, and wherein said SEI layer exhibits, through analysis under a scanning electron microscope with an energy dispersive spectrometer, a resultant atomic peak of phosphorous levels greater than 1.5.

20. The method of claim 19, wherein said nonwoven separator comprises a mean flow pore size greater than or equal to 0.1 microns.

21. The method of claim 19, wherein said termination voltage is greater than or equal to 3.6 volts.

22. The method of claim 19, wherein said constant voltage charging step is for greater than 9 hours.

23. The method of claim 19 wherein said SEI layer present on said separator exhibits, subsequent to both said charging steps, through analysis under a scanning electron microscope with energy dispersive spectrometer resultant atomic peaks of at most 70 carbon, at least 8 oxygen, and at least 5 fluorine.
